(19) United States
(12) Patent Application Publication
(10) Pub. No.: US 2025/0162731 A1
(43) Pub. Date: May 22, 2025

(54) SYSTEMS AND METHODS FOR COLLECTING ORBITAL DEBRIS

(71) Applicant: The Johns Hopkins University, Baltimore, MD (US)

(72) Inventors: Aayush R. Sharma, Washington, DC (US); Greta K. Kintzley, Serverna Park, MD (US); Rachel K. Hartig, Baltimore, MD (US); Samuel J. Audia, Columbia, MD (US); Matthew E. Nagle, Takoma Park, MD (US)

(73) Assignee: The Johns Hopkins University, Baltimore, MD (US)

(21) Appl. No.: 18/947,884

(22) Filed: Nov. 14, 2024

Related U.S. Application Data
(60) Provisional application No. 63/599,747, filed on Nov. 16, 2023.

(51) Int. Cl. B64G 1/10

(52) U.S. Cl. CPC B64G 1/1081

(57) ABSTRACT

Disclosed herein are systems and methods of capturing orbital and sub-orbital extraterrestrial debris. The system is directed to a pouch comprising a semi-penetrable outer fabric covering a debris particle-capturing core. Also disclosed herein are methods of producing the pouch. Further described herein are methods of capturing debris with a deployed pouch.

### CROSS-REFERENCE TO RELATED APPLICATIONS

The present application claims priority to and filing benefit of U.S. Provisional Patent Application No. 63/599,747, filed on Nov. 16, 2023, which is incorporated herein by reference in its entirety.

### BACKGROUND

Existing space shielding solutions are effective at forming a protective barrier for spacecraft from debris, but often result in more debris particles being expelled back into an already congested space environment, increasing the risk of future collisions. Previous missions have shown that aerogels could be used successfully in the space environment to capture particles moving at hypervelocities (e.g., orbital velocities and speeds), but these solutions were only successful for particles that are orders of magnitude smaller than the particle sizes that can cause significant damage to spacecraft.

### SUMMARY

There exists a need for a versatile system to capture extraterrestrial orbiting debris particles having the size and weight constraints consistent with operational deployment while performing as either an independent capture device or supplement shielding on existing spacecraft.

Some embodiments of the present disclosure include a system having at least one particle-absorbing core comprising an impact surface, an exit surface disposed opposite the impact surface, and an absorptive media disposed between the impact surface and the exit surface. In some embodiments, the system can also include a semi-penetrable pouch having an impact membrane disposed on the impact surface of the particle-absorbing core and a capture membrane disposed on the exit surface of the particle-absorbing core, the semi-penetrable pouch configured to envelop the particle-absorbing core material.

In some embodiments, the particle-absorbing core can be a hybrid polymer aerogel material and the semi-penetrable pouch can be a size-tunable fabric weave configured to pass a debris particle through the impact membrane.

In some embodiments, the impact membrane can be further configured to at least partially fracture the debris particle and the particle-absorbing core can be configured to capture and dissipate the at least partially fractured debris particle.

In some embodiments, the system can further include at least one semi-penetrable inner membrane and a second particle-absorbing core, such that the at least one semi-penetrable inner membrane can be disposed between the at least one particle-absorbing core and the second particle-absorbing core.

In further embodiments, the system can include a third particle-absorbing core and a second semi-penetrable inner membrane, such that the second semi-penetrable inner membrane is disposed between the second particle-absorbing core and the third particle absorbing core.

In some embodiments, the at least one semi-penetrable inner membrane is configured to at least partially block the at least partially fractured debris particle, the second absorbing core is configured to capture and dissipate the at least partially fractured debris particle, the second semi-penetrable inner membrane is configured to at least partially block the at least partially fractured debris particle, and the third particle-absorbing core is configured to capture the at least partially fractured debris particle.

Some embodiments of the present disclosure also include a method of manufacturing the system, including disposing a semi-penetrable impact membrane on an impact surface of a first particle-absorbing core, disposing a semi-penetrable capture membrane on an exit surface of the particle-absorbing core, and bonding an edge of the semi-penetrable impact membrane to an edge of the semi-penetrable capture membrane.

In some embodiments, the method can further include disposing a semi-penetrable inner membrane on the exit surface of the particle-absorbing core, disposing a second particle-absorbing core to the semi-penetrable inner membrane disposed on the exit surface of the particle-absorbing core, wherein an impact surface of the second particle-absorbing core is adjacent to the semi-penetrable inner membrane, disposing the semi-penetrable capture membrane on an exit surface of the second particle-absorbing core, and bonding an edge of the semi-penetrable impact membrane to an edge of the semi-penetrable capture membrane.

In certain embodiments, the method can still further include disposing a second semi-penetrable inner membrane on the exit surface of the second particle-absorbing core, disposing a third particle-absorbing core on the second semi-penetrable inner membrane, wherein an impact surface of the third particle-absorbing core is adjacent to the second semi-penetrable inner membrane, disposing the semi-penetrable capture membrane on an exit surface of the third particle-absorbing core, and bonding an edge of the semi-penetrable impact membrane to an edge of the semi-penetrable capture membrane.

In some embodiments, the first particle-absorbing core can include a hybrid polymer aerogel having a first density, the second particle-absorbing core can have a hybrid polymer aerogel having a second density, and the third particle-absorbing core comprises a hybrid polymer aerogel having a third density.

Covered embodiments are defined by the claims, not this summary. This summary is a high-level overview of various aspects of the embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

### BRIEF DESCRIPTION OF THE DRAWINGS

The accompanying drawings are incorporated herein and form a part of the specification.

FIG. 1 is a schematic of the debris particle capture system according to some embodiments of the present disclosure.

FIG. 2 is a cross-sectional schematic illustrating a device architecture according to some embodiments of the present disclosure.

FIG. 3 is a cross-sectional schematic illustrating a device architecture according to some embodiments of the present disclosure.

FIG. 4 is a cross-sectional schematic illustrating a device architecture according to some embodiments of the present disclosure.

FIG. 5 is a cross-sectional schematic illustrating a device architecture according to some embodiments of the present disclosure.

FIG. 6 is a flowchart showing a method according to some embodiments of the present disclosure.

FIG. 7 is a flowchart showing a method according to some embodiments of the present disclosure.

FIG. 8 is a flowchart showing a method according to some embodiments of the present disclosure.

In the drawings, like reference numbers generally indicate identical or similar elements.

### DETAILED DESCRIPTION

As used herein, the meaning of “a,” “an,” and “the” includes singular and plural references unless the context clearly dictates otherwise.

All ranges disclosed herein are to be understood to encompass any and all endpoints as well as any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

The term “and/or” when used in a list of two or more items, means that any one of the listed items can be employed by itself or in combination with any one or more of the listed items. For example, the expression “A and/or B” is intended to mean either or both of A and B, i.e., A alone, B alone, or A and B in combination. The expression “A, B and/or C” is intended to mean A alone, B alone, C alone, A and B in combination, A and C in combination, B and C in combination or A, B, and C in combination.

Embodiments of the present disclosure can be directed to a system that can include an absorptive medium enveloped by a semi-penetrable outer membrane (e.g., a cover). Methods of making the system can include creating polymer-aerogel hybrid absorptive mediums, aerogel absorptive mediums, and/or polymer gel absorptive mediums. Methods of capturing extraterrestrial debris using the system can include allowing a debris particle to impact the semi-penetrable outer membrane, at least partially penetrate the semi-penetrable membrane (e.g., fracture upon impact and pass through the semi-penetrable membrane), and come to a rest within the absorptive medium.

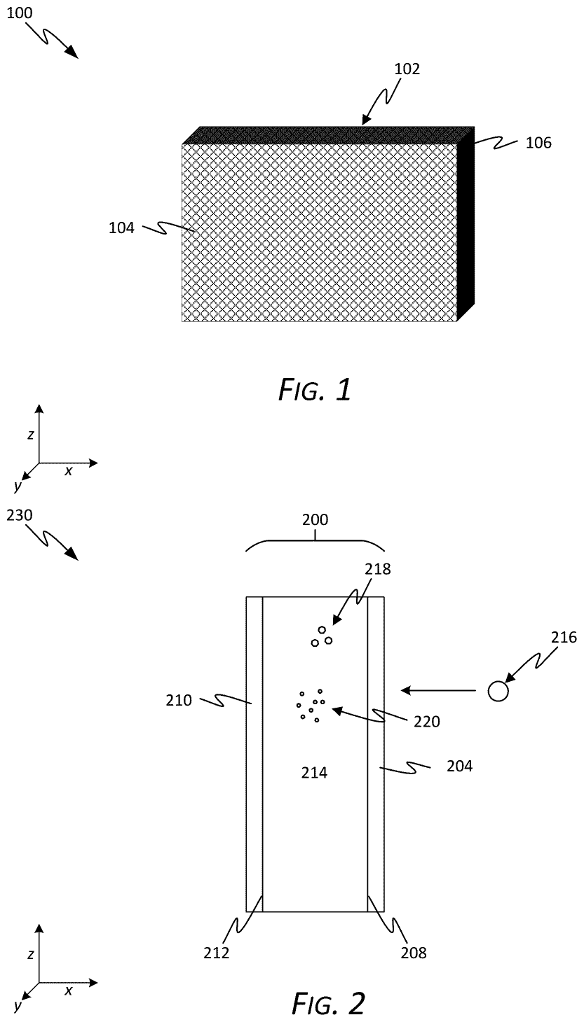

FIGS. 1 and 2 respectively show exterior and cross-sectional device architectural views of the debris particle capture system 100 according to some embodiments of the present disclosure. For example, debris particle capture system 100 can be a semi-penetrable pouch 102.

In one aspect, semi-penetrable pouch 102 can comprise an impact membrane 104 disposed on an impact surface 208 (FIG. 2) of a particle-absorbing core 200 (FIG. 2) and a capture membrane 210 (FIG. 2) disposed on an exit surface 212 (FIG. 2) of particle-absorbing core 200. In one aspect, semi-penetrable pouch 102 can be configured to envelop particle-absorbing core 200 along a seam 106.

FIGS. 2-5 show illustrative examples of device architecture within semi-penetrable pouch 102. In other words, FIGS. 2-5 show possible inner configurations of debris particle capture system 100 (FIG. 1).

FIG. 2 shows a device architecture according to some embodiments of the present disclosure. For example, debris particle capture system 100 can have device architecture having at least one particle-absorbing core 200 enveloped by semi-penetrable pouch 102 (FIG. 1). In some embodiments, particle-absorbing core 200 comprises impact surface 208, capture membrane 210 disposed opposite impact membrane 204, and an absorptive media 214 disposed between impact membrane 204 and capture membrane 210. In some embodiments, impact membrane 204 and capture membrane 210 can be semi-penetrable pouch 102.

In some embodiments, debris particle capture system 100 can be configured to capture a debris particle 216. For example, debris particle 216 can approach debris particle capture system 100 along the x-axis in the example of FIG. 2 and contact impact membrane 204. In some embodiments, debris particle 216 can pass through impact membrane 204 and at least partially fracture upon contacting impact membrane 204. For example, debris particle 216 can fracture such that debris particle 216 is broken into a plurality of debris pieces 218 having diameters slightly less than the diameter of debris particle 216.

In another example, debris particle 216 can pass through impact membrane 204 and considerably fracture. For example, debris particle 216 can fracture such that debris particle 216 is broken into a plurality of debris particulates 220 having diameters much less than the diameter of debris particle 216.

In some embodiments, after debris particle 216 is fractured, absorptive media 214 can dissipate plurality of debris pieces 218 and/or plurality of debris particulates 220 throughout absorptive media 214.

In some embodiments, the at least partially fractured particles (e.g., plurality of debris pieces 218 and/or plurality of debris particulates 220) can be trapped within absorptive media 214 by capture membrane 210. For example, the at least partially fractured particles can enter debris particle capture system 100 through impact membrane 204 and impact surface 208 and become trapped within absorptive media 214 by capture membrane 210.

In some embodiments, impact surface 208 can be an interface between absorptive media 214 and impact membrane 204. Additionally, exit surface 212 can be an interface between absorptive media 214 and capture membrane 210. In other words, impact surface 208 and exit surface 212 can be the outer surfaces of absorptive media 214 that can be in contact with semi-penetrable pouch 102 (FIG. 1).

In some embodiments, the absorptive media 214 can be a hybrid polymer aerogel material and the semi-penetrable pouch 102 can be a size-tunable fabric weave configured to pass a debris particle 216 through impact membrane 204. For example, the hybrid polymer aerogel material can include an aerogel having polymer-coated aerogel particles and/or a polymer cross-linked internal network (e.g., polyimide aerogels).

In other examples, the size-tunable fabric weave can include spun fibers configured to dissipate impact energy. The weave of the spun fibers can be tightened or loosened depending on the size of debris particle 216 sought to be captured. In some embodiments, impact membrane 204 can be a metal, a metal alloy, silica, or any suitable penetrable or semi-penetrable membrane (e.g., a metal foil, a metal plate, a metal sheet, or any suitable metal product).

In other words, a tighter woven semi-penetrable pouch 102 can be deployed to capture smaller debris particles 216 having a diameter up to about, e.g., 3 millimeters (mm), or from about 500 microns (μm) to about 3 mm, from about 1 mm to about 3 mm, from about 1.5 mm to about 3 mm, from about 500 μm to about 2.5 mm, or from about 900 μm to about 2.9 mm. In other examples, a loosely woven semi-penetrable pouch 102 can be deployed to capture larger debris particles 216 having a diameter up to about, e.g., 5 cm, or from about 3 mm to about 5 cm, from about 3.1 mm to about 5 cm, from about 3.5 mm to about 5 cm, from about 3 mm to about 4.5 cm, or from about 3.25 mm to about 4.9 cm.

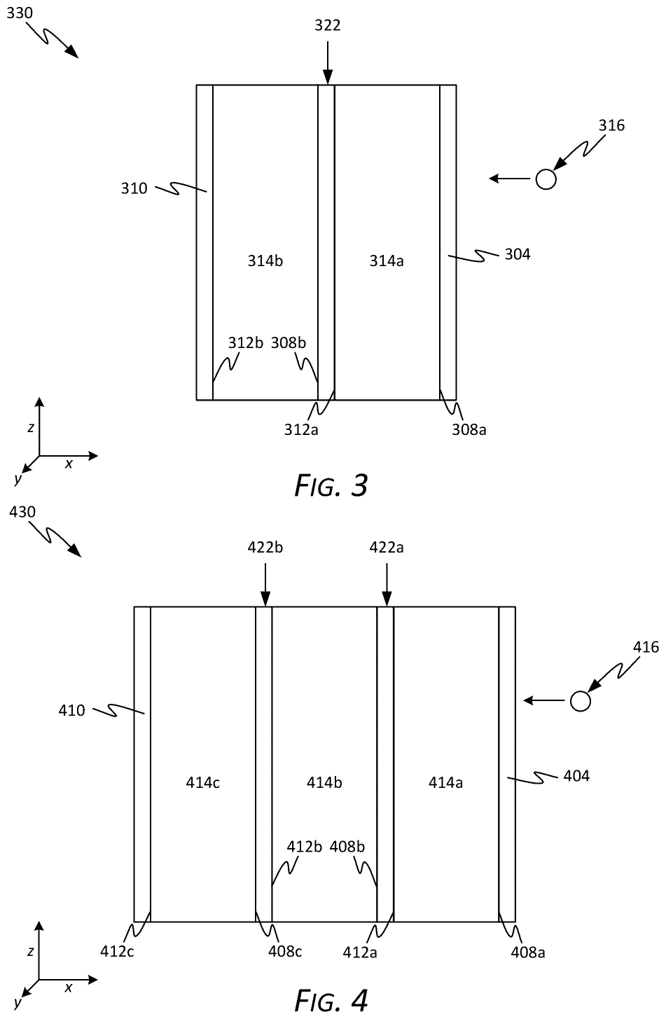

FIG. 3 shows a schematic illustrating a device architecture 330 according to some embodiments of the present disclosure. For example, debris particle capture system 100 (FIG. 1) can have device architecture 330 having at least a pair of particle-absorbing cores (e.g., two of particle absorbing core 200) comprising an impact membrane 304, a capture membrane 310, absorptive media 314a disposed between impact membrane 304 and capture membrane 310, and an impact surface 308a adjacent to impact membrane 304. In some aspects, device architecture 330 can include a semi-penetrable inner membrane 322 adjacent to exit surface 312a of absorptive media 314a.

In some aspects, device architecture 330 comprises a second absorptive media 314b with impact surface 308b adjacent to semi-penetrable inner membrane 322. Exit surface 312b of absorptive media 314b can be adjacent to capture membrane 310. For example, semi-penetrable inner membrane 322 can be disposed between absorptive media 314a and absorptive media 314b.

In other words, debris particle capture system 100 can include two particle-absorbing cores 200 (FIG. 2) enveloped by semi-penetrable pouch 102 (FIG. 1).

In some embodiments, semi-penetrable inner membrane 322 can be a fiber-spun fabric similar to semi-penetrable pouch 102, a silica tile, a semi-penetrable brick, a semi-penetrable sheet, or any combination thereof.

In some embodiments, semi-penetrable inner membrane 322 can be used to either capture the at least partially fractured debris particle 316 or to further at least partially fracture debris particle 316.

In some embodiments, absorptive media 314b (e.g., the second particle absorbing core in the pair of particle-absorbing cores 300) can have a higher density than absorptive media 314a such that the velocity and/or speed of debris particle 316 can be further slowed upon entry into absorptive media 314b.

FIG. 4 shows a schematic illustrating a device architecture 430 according to some embodiments of the present disclosure. For example, debris particle capture system 100 (FIG. 1) can have device architecture 430 having at least a triplet of particle-absorbing cores (e.g., three of particle absorbing core 200).

In some embodiments, device architecture 430 comprises an impact membrane 404 and a capture membrane 410, absorptive media 414a, absorptive media 414b, and absorptive media 414c. In some embodiments, semi-penetrable inner membrane 422a can be disposed between absorptive media 414a and absorptive media 414b. Semi-penetrable inner membrane 422a can be adjacent to exit surface 412a of absorptive media 414a and impact surface 408b of absorptive media 414b. In further embodiments, semi-penetrable inner membrane 422b can be adjacent to exit surface 412b of absorptive media 414b and impact surface 408c of absorptive media 414c. Exit surface 412c of absorptive media 414c can be adjacent to capture membrane 410. In other words, debris particle capture system 100 can include triplet of particle-absorbing cores 200 enveloped by semi-penetrable pouch 102 (FIG. 1).

In some embodiments, semi-penetrable inner membrane 422a and second semi-penetrable inner membrane 422b can be used to either capture the at least partially fractured debris particle 416 (e.g., at least partially block fractured debris particle 416 in absorptive media 414a) or to further at least partially fracture debris particle 416 before debris particle 416 proceeds into absorptive media 414b. In some embodiments, absorptive media 414c (e.g., the second particle absorbing core of triplet of particle-absorbing cores 400) can have a higher density than absorptive media 414b, and absorptive media 414b can have a greater density than absorptive media 414a such that the velocity and/or speed of debris particle 416 can be further slowed as debris particle 416 passes through absorptive media 414a, absorptive media 414b, and absorptive media 414c.

In some embodiments, absorptive media 414a, absorptive media 414b, and absorptive media 414c can be implemented into debris particle capture system 100 with any suitable variation of densities. For example, absorptive media 414a can have a greater density than both absorptive media 414b and absorptive media 414c, absorptive media 414c can have a density greater than absorptive media 414b and absorptive media 414a, absorptive media 414b can have a density greater than both absorptive media 414c and absorptive media 414a, and so on. In other words, the densities of each of the particle-absorbing cores in the pair of particle-absorbing cores 200 in device architecture 330 and/or the triplet of particle-absorbing cores 200 in device architecture 430 can be tailored to a particular application (e.g., projected size and/or velocity of debris particles 416).

In some embodiments, the particle-absorbing cores 200 can have densities ranging from 0.1 g/cm³-0.55 g/cm³.

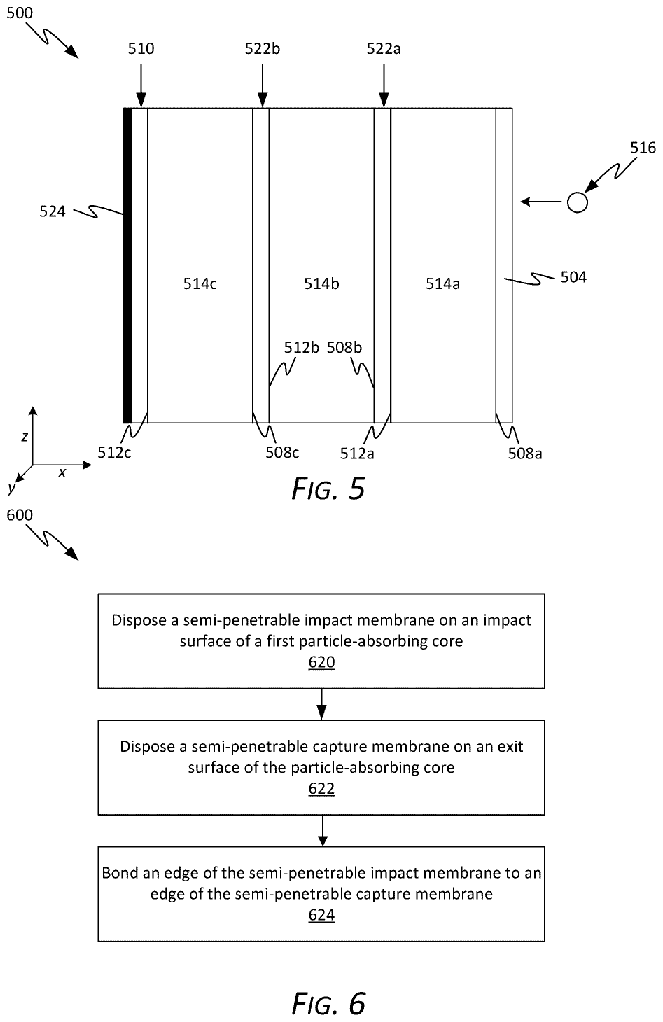

In some embodiments, debris particle capture system 100 can further include a capture plate. FIG. 5 shows a schematic illustrating a device architecture 500 according to some embodiments of the present disclosure. For example, debris particle capture system 100 can include a capture plate 524 disposed on capture membrane 510. For example, capture plate 524 can be a metal plate, a metal alloy plate, a polymer-coated metal plate, a polymer-coated metal alloy plate, a polymer plate, a multi-layered fabric plate, or any combination thereof. In some embodiments, capture plate 524 can stop the motion of debris particle 516 in the event debris particle 516 can pass through each of impact membrane 504, impact surface 508a, absorptive media 514a, exit surface 512a, semi-penetrable inner membrane 522a, impact surface 508b, absorptive media 514b, exit surface 512b, semi-penetrable inner membrane 522b, impact surface 508c, absorptive media 514c, exit surface 512c, and capture membrane 510.

FIG. 6 is a flowchart showing a method 600 according to some embodiments of the present disclosure. In some embodiments, method 600 can provide a debris particle capture system. It is to be appreciated that not all operations need be performed, or be performed in the order shown. In some embodiments, the operations shown relate to FIGS. 1-5.

In some aspects, operation 620 can include disposing semi-penetrable impact membrane 204 (FIG. 2) on an impact surface 208 of a particle-absorbing core 200 (e.g., absorptive media 214, impact surface 208, and exit surface 212).

In operation 622, method 600 can include disposing semi-penetrable capture membrane 210 on exit surface 212 of absorptive media 214.

In operation 624, method 600 can include bonding an edge of semi-penetrable impact membrane 204 to an edge of the semi-penetrable capture membrane 210 along seam 106 (FIG. 1).

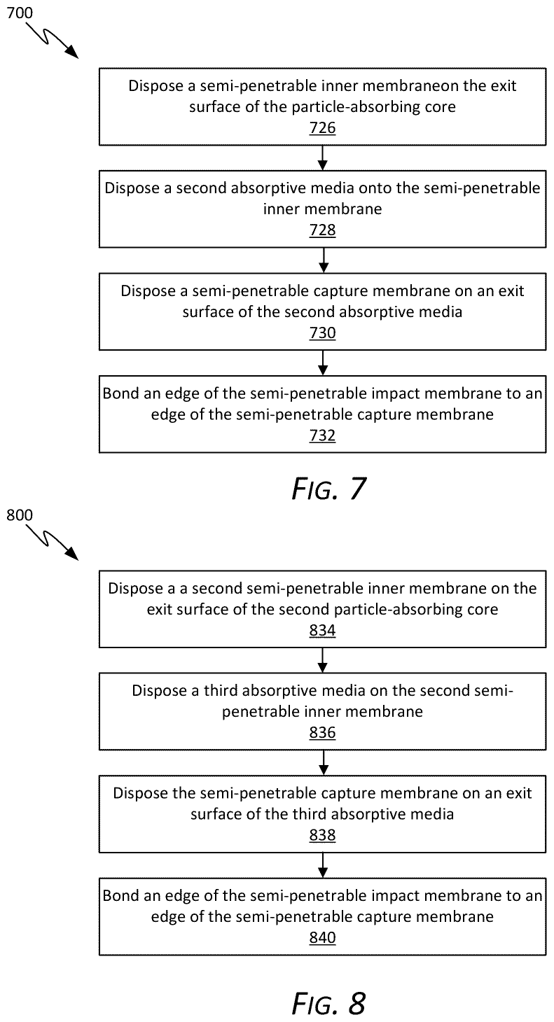

FIG. 7 is a flowchart showing a method 700 according to some embodiments of the present disclosure. It is to be appreciated that not all operations need be performed, or be performed in the order shown. In some embodiments, the operations shown relate to FIGS. 1-5.

In some embodiments, operation 726 can include disposing semi-penetrable inner membrane 322 (FIG. 3) adjacent to exit surface 312a of absorptive media 314a. In some aspects, operation 726 can occur after operation 624 (FIG. 6).

In operation 728, method 700 can include disposing second absorptive media 314b adjacent to semi-penetrable inner membrane 322 disposed adjacent to exit surface 312a of absorptive media 314a.

In some embodiments, impact surface 308b of second absorptive media 314b can be adjacent to semi-penetrable inner membrane 322.

In operation 730, method 700 can include disposing semi-penetrable capture membrane 310 adjacent to exit surface 312b of second absorptive media 314b.

In operation 732, method 700 can include bonding an edge of semi-penetrable impact membrane 304 to an edge of semi-penetrable capture membrane 310 along seam 106 (FIG. 1).

FIG. 8 is a flowchart showing a method 800 according to some embodiments of the present disclosure. It is to be appreciated that not all operations need be performed, or be performed in the order shown. In some embodiments, the operations shown relate to FIGS. 1-5.

In certain embodiments, operation 834 can dispose a second semi-penetrable inner membrane 422b (FIG. 4) adjacent to exit surface 412b of second absorptive media 414b. In some aspects, operation 834 can occur after operation 732.

In operation 836, method 700 can include disposing a third absorptive media 414c adjacent to second semi-penetrable inner membrane 422b.

For example, impact surface 408c of third absorptive media 414c can be adjacent to second semi-penetrable inner membrane 422b.

In operation 838, the method can include disposing semi-penetrable capture membrane 410 on exit surface 412c of third absorptive media 414c.

In operation 840, the method can include bonding an edge of semi-penetrable impact membrane 404 to an edge of semi-penetrable capture membrane 410 to provide debris particle capture system 100 (FIG. 1).

In further embodiments, the method can include arranging the particle-absorbing cores in any suitable order by density of the absorptive medias 414a, 414b, and 414c, as illustrated in Table 1 below.

TABLE 1
Absorptive Media Density Arrangement Examples

| Absorptive Media | Absorptive Media | Absorptive Media |
|---|---|---|
| 414a | 414b | 414c |
| High | Medium | Low |
| Low | Medium | High |
| Low | Low | High |
| Low | High | High |
| High | High | High |
| Medium | Low | High |
| High | High | Low |

It is to be appreciated that not all particle-absorbing core densities need be provided in the quantity or order shown. In one example, architecture 430 is considered. In some embodiments, the densities of the particle-absorbing cores 200 can be provided in any order of any density, and any quantity of particle-absorbing cores can be employed.

In some embodiments, debris particle capture system 100 (FIG. 1) can be deployed in cislunar space in a shield configuration. For example, an array of debris particle capture system 100 can be attached to an expanding armature (e.g., umbrella architecture) that can be collapsed for launch from Earth and configured to expand into a shield shape upon deployment in cislunar space.

In some embodiments, debris particle capture system 100 (FIG. 1) can be deployed in an expanding radius architecture configured to unfold radially. For example, a plurality of arrays described previously can be attached at a common axis and configured to open to provide a super array comprised of a radially symmetric plurality of arrays described above.

In some embodiments, debris particle capture system 100 (FIG. 1) can be employed in any suitable armor application seeking to block and/or capture a projectile. For example, debris particle capture system 100 can be employed in vehicular armor, body armor, blast protection, personal shielding, or any application requiring protection from projectiles.

In some embodiments, debris particle capture system 100 (FIG. 1) can be employed to enhance currently available extraterrestrial vehicle or satellite shielding apparatus or techniques. For example, debris particle captures system 100 can be used to enhance the existing shielding deployed on the International Space Station (ISS).

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A system, comprising:
at least one particle-absorbing core comprising an impact surface, an exit surface disposed opposite the impact surface, and an absorptive media disposed between the impact surface and the exit surface; and
a semi-penetrable pouch comprising an impact membrane disposed on the impact surface of the particle-absorbing core and a capture membrane disposed on the exit surface of the particle-absorbing core, the semi-penetrable pouch configured to envelop the particle-absorbing core material.

2. The system of claim 1, wherein the particle-absorbing core comprises a hybrid polymer aerogel material.

3. The system of claim 1, wherein the semi-penetrable pouch comprises a size-tunable fabric weave configured to pass at least a debris particle through the impact membrane.

4. The system of claim 3, wherein the impact membrane is further configured to at least partially fracture the debris particle.

5. The system of claim 4, wherein the particle-absorbing core is configured to capture and dissipate the at least partially fractured debris particle.

6. The system of claim 5, further comprising at least one semi-penetrable inner membrane.

7. The system of claim 6, further comprising a second particle-absorbing core.

8. The system of claim 7, wherein the at least one semi-penetrable inner membrane is disposed between the at least one particle-absorbing core and the second particle-absorbing core.

9. The system of claim 8, further comprising a third absorbing core and a second semi-penetrable inner membrane.

10. The system of claim 9, wherein the second semi-penetrable inner membrane is disposed between the second particle-absorbing core and the third particle absorbing core.

11. The system claim 10, wherein the at least one semi-penetrable inner membrane is configured to at least partially block the at least partially fractured debris particle.

12. The system of claim 11, wherein the second absorbing core is configured to capture and dissipate the at least partially fractured debris particle.

13. The system of claim 12, wherein the second semi-penetrable inner membrane is configured to at least partially block the at least partially fractured debris particle.

14. The system of claim 13, wherein the third particle-absorbing core is configured to capture the at least partially fractured debris particle.

15. A method comprising:
disposing a semi-penetrable impact membrane on an impact surface of a first particle-absorbing core;
disposing a semi-penetrable capture membrane on an exit surface of the particle-absorbing core; and
bonding an edge of the semi-penetrable impact membrane to an edge of the semi-penetrable capture membrane.

16. The method of claim 15, further comprising:
disposing a semi-penetrable inner membrane on the exit surface of the particle-absorbing core;
disposing a second particle-absorbing core to the semi-penetrable inner membrane disposed on the exit surface of the particle-absorbing core, wherein an impact surface of the second particle-absorbing core is adjacent to the semi-penetrable inner membrane;
disposing the semi-penetrable capture membrane on an exit surface of the second particle-absorbing core; and
bonding an edge of the semi-penetrable impact membrane to an edge of the semi-penetrable capture membrane.

17. The method of claim 16, further comprising:
disposing a second semi-penetrable inner membrane on the exit surface of the second particle-absorbing core;
disposing a third particle-absorbing core on the second semi-penetrable inner membrane, wherein an impact surface of the third particle-absorbing core is adjacent to the second semi-penetrable inner membrane;
disposing the semi-penetrable capture membrane on an exit surface of the third particle-absorbing core; and
bonding an edge of the semi-penetrable impact membrane to an edge of the semi-penetrable capture membrane.

18. The method of claim 17, wherein the first particle-absorbing core comprises a hybrid polymer aerogel having a first density.

19. The method of claim 17, wherein the second particle-absorbing core comprises a hybrid polymer aerogel having a second density.

20. The method of claim 17, wherein the third particle-absorbing core comprises a hybrid polymer aerogel having a third density.
